(19) United States
(12) Patent Application Publication
(10) Pub. No.: US 2005/0099956 A1
(43) Pub. Date: May 12, 2005

(54) Load distribution type network fault monitoring system and method of broadband router

(75) Inventor: Kenji Mangetsu, Shizuoka (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/888,263

(22) Filed: Jul. 8, 2004

(30) Foreign Application Priority Data
Nov. 7, 2003 (JP) 2003-273798

(51) Int. Cl. H04L 12/26; H04L 1/00; H04L 12/28; H04J 1/16; H04L 12/56; H04J 3/14

(52) U.S. Cl. 370/242; 370/220; 370/400

(57) ABSTRACT

The present invention is a load distribution type network fault monitoring system of a broadband router, which is connected to a plurality of client terminals and which has a function of accessing the Internet, the load distribution type network fault monitoring system comprising: a fault monitoring section in the broadband router for monitoring and recording a connection situation between the client terminals and the broadband router, and an abnormality in data communication contents; and a network monitoring machine connected to the Internet to receive collectively the connection situation and the abnormality in data communication contents monitored by the fault monitoring section, at regular intervals, sum up the received data, and ascertain a network state.

### BACKGROUND OF THE INVENTION

The present invention relates to a broadband router such as an ADSL (Asymmetric Digital Subscriber Line) router having a function of accessing the Internet. In particular, the present invention relates to a broadband router that conducts load distribution of network fault monitoring.

In the conventional load distribution system in the network, in order to distribute the server load on the Internet and reduce packets, the router is provided with a function of analyzing an address of an IP packet passing through it, a traffic monitoring function of monitoring a destination IP address, a function of inquiring of a server having a high access frequency whether a mirror server is not present, a mirror server analysis control function of developing IP addresses of a server and a mirror server on a mirror server table, comparing them with a routing table and searching for a server having a short distance, and an IP address translation function of responding to presence of a server having a short distance by creating an IP address translation association table, translating an address of an IP packet containing a destination IP address stored in the IP address translation association table to an IP address having a short distance, and transmitting the resultant IP address (for example, see Japanese Patent Publication No. 2003-022226 A, pages 4 and 5 and FIG. 2).

In the conventional network distributed management system, in order to efficiently monitor a large-scaled and complicated network by using a plurality of management servers, network monitoring is conducted by dividing a plurality of nodes connected to the network into a plurality of groups to form network groups, installing a network monitoring server for each of the network groups, and causing a network monitoring server in each network group to acquire and share management information other network monitoring servers have (for example, see Japanese Patent Publication No. 2001-144761 A, page 4 and FIG. 1).

In regard to the above-described conventional technique, information sending using servers have increased in recent years as the internet broadband networks spread and the network operation solution becomes diversified.

In particular, since it has become possible for even an individual to easily utilize the Internet constantly connection service and fast communication service using the ADSL or the like, interactive information exchange has become easy.

On the information receiving side, therefore, the received traffic is increasing and the load imposed on its processing is increasing. Therefore, load reduction is becoming a problem.

In a network monitoring system using the conventional technique, there is a problem that fault information collecting servers concentrate to one place and the load becomes high.

Because of the increased cost, the processing becomes slow. Accordingly, impairment in the real time property such as hindrance in rapid handling and partial loss in large quantity of information processing occurs, resulting in a new problem. It is a serious problem in a system required to have rapidness in fault management and so on.

### SUMMARY OF THE INVENTION

In view of the above-described problems, an object of the present invention is to provide a load distribution type network system, and method, of broadband router that distributes the load imposed on a fault information summarizing server and makes possible rapid processing against a load increase.

In order to solve the above-described problems, the present invention provides a load distribution type network fault monitoring system of a broadband router, which is connected to a plurality of client terminals and which has a function of accessing the Internet, the load distribution type network fault monitoring system comprising: a fault monitoring section in the broadband router for monitoring and recording a connection situation between the client terminals and the broadband router, and an abnormality in data communication contents; and a network monitoring machine connected to the Internet to receive collectively the connection situation and the abnormality in data communication contents monitored by the fault monitoring section, at regular intervals, sum up the received data, and ascertain a network state.

Furthermore, the fault monitoring section monitors a physical line error between the broadband router and an office side line accommodation apparatus connected to the broadband router, and a PPP session state between the broadband router and a BAS (Broadband Access Server) which is connected between the office side line accommodation apparatus and the Internet, and records the monitored line error and PPP session state. And the network monitoring machine receives the physical line error and the PPP session state monitored by the fault monitoring section, collectively at regular intervals, sums up the received data, and ascertains the network state.

Furthermore, if a physical line error is a physical line disconnection, then the fault monitoring section records a line disconnection situation and a PPP session state, and after the line restoration has been detected, the fault monitoring section transmits the recorded line disconnection situation PPP session state.

Furthermore, a plurality of network monitoring machines are provided on the Internet, and a network monitoring machine serving as transmission destination of the monitored connection situation and abnormality in data communication contents, or the monitored physical line error and PPP session state is set for each of the fault monitoring sections in the broadband routers.

Furthermore, the broadband router comprises an HTTP/mirror server section in which the HTTP is installed. The HTTP/mirror server section has a mirror server function for the network monitoring machine. And the HTTP/mirror server section downloads mirrored contents from the network monitoring machine, sums up data transmitted in access from the client terminals, and transmits the summed up data collectively to the network monitoring machine at regular intervals.

Furthermore, the broadband router comprises an SMTP/mirror server section in which the SMTP is installed. The SMTP/mirror server section has a mirror server function for the network monitoring machine. And the SMTP/mirror server section downloads mirrored contents from the network monitoring machine, sums up data transmitted in access from the client terminals, and transmits the summed up data collectively to the network monitoring machine at regular intervals.

According to the present invention, the fault monitoring section in the broadband router collects fault information and distributes the load. Unlike the conventional technique, therefore, fault information collecting servers is prevented from concentrating to one place and the load is prevented from becoming high. It become possible to collect the load increase and cope with it rapidly. Partial loss in large quantity of information processing is prevented.

Therefore, it becomes possible to improve the communication load over the whole network by reducing the network load.

In addition, the present function is added only to a relay router and it is not added to each client terminal. Therefore, the introduction cost can also be reduced. Furthermore, the present function can be introduced without depending upon a platform in an existing network.

This makes it easy to expand the transmission content alteration function, makes possible load distribution, and makes it possible to construct a large scale data summing up system in a remote business or the like. Since the HTTP or SMTP is installed on the broadband router as one body, there is an advantage that the required quantity of resources is small.

As a result, it becomes possible to monitor not only the line state but also the session state. Accordingly, it becomes possible for the network manager to suitably cope with a user, such as a beginner, who is not strong on fault cause analysis.

It becomes possible to install a plurality of network monitoring machines on the Internet, and the load imposed on the network monitoring machine side by the monitoring processing is further reduced.

### BRIEF DESCRIPTION OF THE DRAWINGS

FIG. 1 is a block diagram showing a schematic configuration of a load distribution type network fault monitoring system of an ADSL router according to the present invention;

FIG. 2 is a diagram showing an example of monitoring processing operation of a fault monitoring section 131A in an ADSL router 131 shown in FIG. 1;

FIG. 3 is a diagram showing another example of monitoring processing operation of a fault monitoring section 131A in an ADSL router 131 shown in FIG. 1;

FIG. 4 is a block diagram showing a schematic configuration of a load distribution type network fault monitoring system of an ADSL router according to a variant of FIG. 1;

FIG. 5 is a diagram showing an operation example of an HTTP/mirror server section 131B in an ADSL router 131; and

FIG. 6 is a diagram showing a variant of FIG. 5 and it is a diagram showing another operation example of an HTTP/mirror server section 131B in an ADSL router 131.

### DESCRIPTION OF THE PREFERRED EMBODIMENTS

Hereafter, embodiments of the present invention will be described with reference to the drawings.

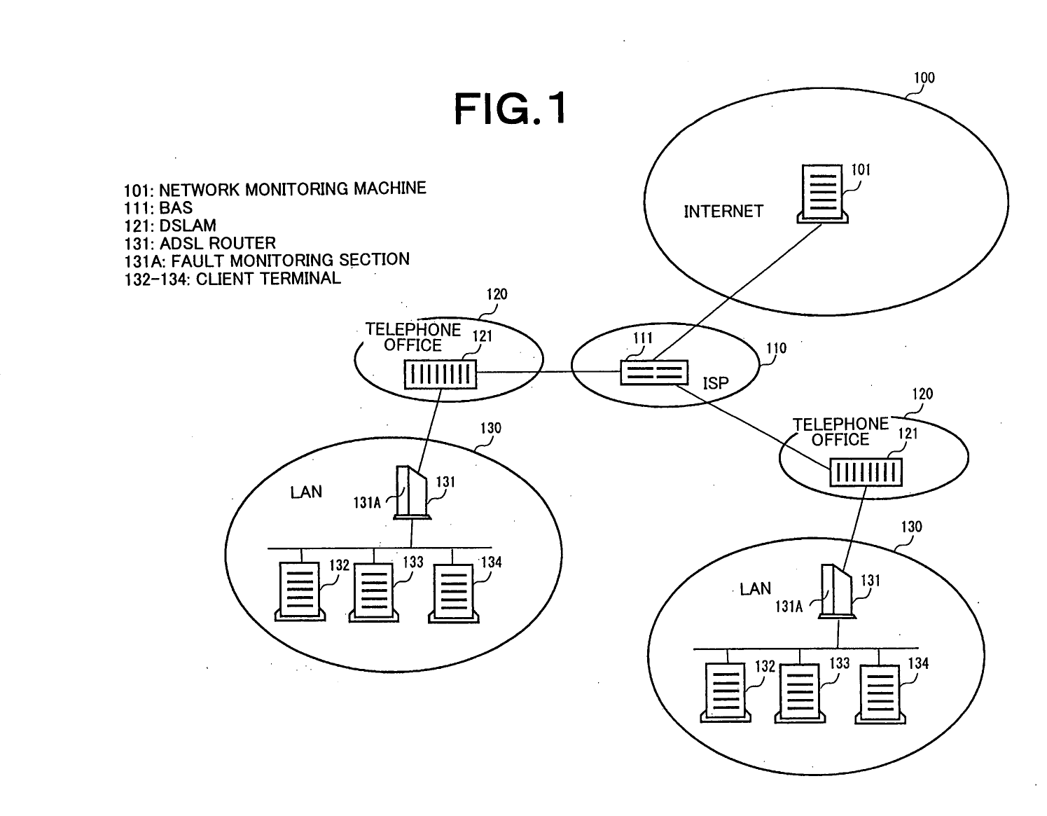

FIG. 1 is a block diagram showing a schematic configuration of a load distribution type network fault monitoring system of a broadband router according to the present invention.

As shown in FIG. 1, a load distribution type network fault monitoring system of an ADSL router includes an Internet 100. A network monitoring machine 101 is provided in the Internet 100. The network monitoring machine 101 is a computer having a function of managing network operation information on the Internet 100.

The load distribution type network fault monitoring system of the ADSL router further includes an ISP (Internet Service Provider) 110, which belongs to a communication business company having a function of providing connection to the Internet 100 as ADSL service. A BAS (Broadband Access Server) 111 is provided in the Internet service provider 110. The BAS 111 is an apparatus having a function of collecting traffic from users and distributing the traffic among connection distributions. The network monitoring machine 101 is connected to the BAS 111.

The load distribution type network fault monitoring system of the ADSL router further includes telephone offices 120. A DSLAM (Digital Subscriber Line Access Multiplexer) is provided in each of the telephone offices 120. The DSLAM 121 is an ADSL office side apparatus, which has a function of accommodating ADSL lines and connecting the ADSL lines to the Internet 100 via the BAS 111 by using the communication business company providing the ADSL service.

The load distribution type network fault monitoring system of the ADSL router further includes LANs (Local Area Networks) 130. An ADSL router 131 is provided in each of the LANs 130. A plurality of client terminals 132, 133 and 134 are connected to the ADSL router 131. The ADSL router 131 is a router that is present at a junction node between the client terminals 132, 133 and 134 and the DSLAM 121, and that has a function of allowing access to the Internet 100 from the client terminals 132, 133 and 134.

A fault monitoring section 131A is provided in the ADSL router 131. The fault monitoring section 131A has a function of monitoring the connection situation of the client terminals 132, 133 and 134 and an abnormality in data communication contents, recording the connection state and abnormal data obtained by monitoring, as a log, bringing them together at regular intervals, and transmitting the log to the network monitoring machine 101 via the telephone office 120 and the Internet service provider 110.

In the load distribution type network fault monitoring system of the ADSL router according to the present invention, the monitoring processing operation is divided into operation between the client terminals 132, 133 and 134 and the ADSL router 131, and operation between the ADSL router 131 and the BAS 111.

Hereafter, embodiments will be described by taking an ADSL router as an example. However, it is not necessary that a WAN (Wide Area Network) side interface is an ADSL, but the embodiments can be applied to all broadband routers such as CATV, FTTH (Fiber to the Home), or the like. The LAN side interface can also be applied to all kinds.

### First Embodiment

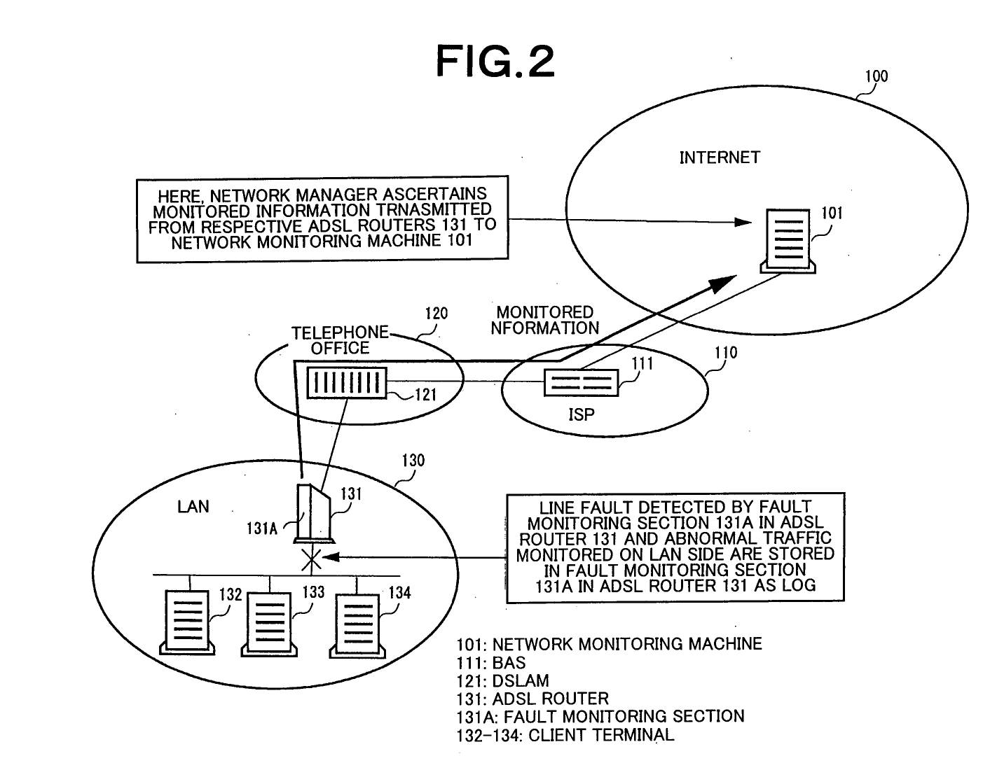

FIG. 2 is a diagram showing an example of monitoring processing operation in the fault monitoring section 131A in the ADSL router 131 shown in FIG. 1.

As shown in FIG. 2, the fault monitoring section 131A in the ADSL router 131 monitors the connection situation, such as a line fault, with the client terminals 132, 133 and 134 on the LAN 130 side.

Furthermore, for example, if there is a large quantity of traffic having unknown destinations and there is an abnormality in data communication contents in the client terminals 132, 133 and 134 of the LAN 130, then the fault monitoring section 131A monitors the situation. In the ADSL router 131, data of the monitored connection situation and abnormal information are recorded.

By the way, the fault monitoring section 131A in the ADSL router 131 conducts the transmission and reception analysis of the data on the basis of a source IP address or the like.

The fault monitoring section 131A transmits the data of the monitored connection situation and abnormal information collectively to the network monitoring machine 101 in the Internet 100 at regular intervals.

In the network monitoring machine 101, data received from the ADSL router 131 are summed up, and the network manager ascertains the network state and conducts suitable handling.

### Second Embodiment

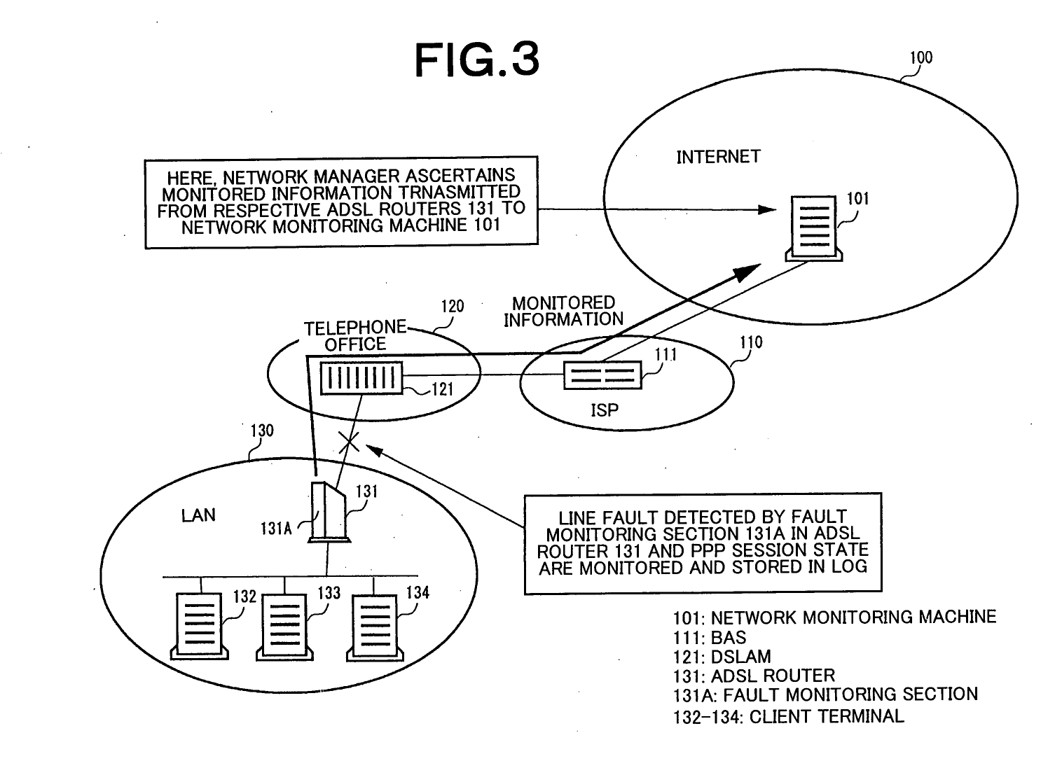

FIG. 3 is a diagram showing another example of monitoring processing operation in the fault monitoring section 131A in the ADSL router 131 shown in FIG. 1. As compared with FIG. 2, the fault monitoring section 131A in the ADSL router 131 shown in FIG. 3 monitors physical line errors between the ADSL router 131 and the DSLAM 121, a PPP (Point to Point Protocol) session state between the ADSL router 131 and the BAS 111, and the state of the communication session, records data of the monitoring result as a log, and transmits the log to the network monitoring machine 101 at regular intervals.

If there is a physical line disconnection between the ADSL router 131 and the DSLAM 121, then transmission to the higher rank network monitoring machine 101 becomes impossible. After the line restoration has been detected, data of the monitoring result is transmitted.

In the network monitoring machine 101, data received from the ADSL router 131 are summed up, and the network manager ascertains the network state and conducts suitable handling, in the same way as the foregoing description.

### Third Embodiment

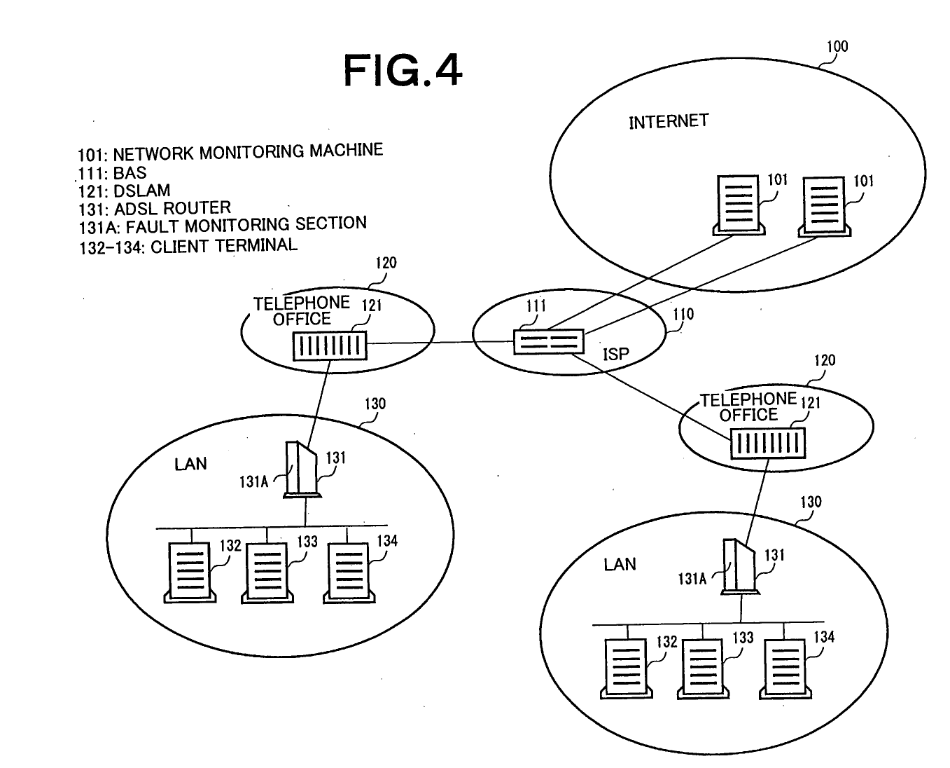

FIG. 4 is a block diagram showing a schematic configuration of a load distribution type network fault monitoring system of an ADSL router according to a variant of FIG. 1.

As compared with FIG. 1, in the load distribution type network fault monitoring system of the ADSL router shown in FIG. 4, a plurality of network monitoring machines 101 are provided on the Internet 100, and a network monitoring machine 101 on the Internet 100 of the transmission destination is set for each of the fault monitoring sections 131A respectively in ADSL routers 131.

As a result, it becomes possible to install a plurality of network monitoring machines 101 on the Internet 100. As compared with the monitoring processing shown in FIGS. 2 and 3, the load on the network monitoring machine 101 side is also reduced.

### Fourth Embodiment

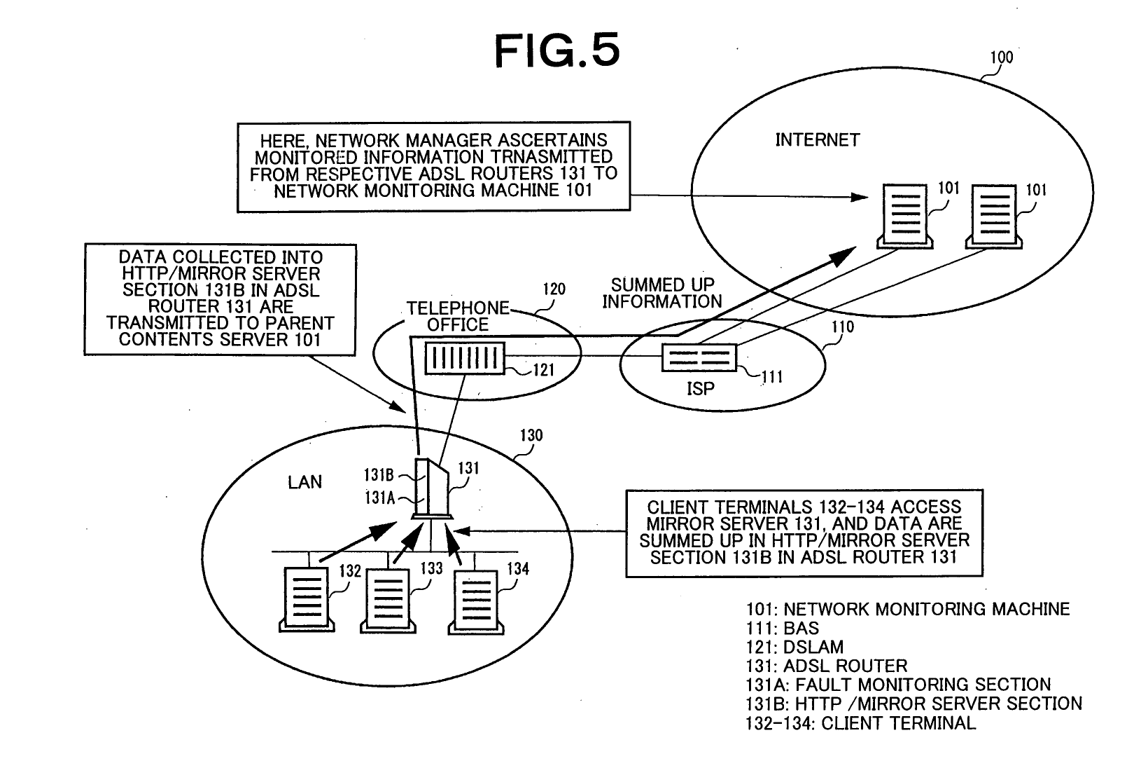

With reference to FIG. 5, an HTTP/mirror server section 131B having the HTTP (Hypertext Transfer Protocol) is provided in the ADSL router 131, and the HTTP/mirror server section 131B has the mirror server function of the network monitoring machine 101.

In other words, the network monitoring machine 101 serves as a parent contents server for the ADSL router 131, and the ADSL router 131 serves as a child server for the network monitoring machine 101.

FIG. 5 is a diagram showing an operation example in the HTTP/mirror server section 131B in the ADSL router 131.

In the HTTP/mirror server section 131B in the ADSL router 131, data are written from the network monitoring machine 101 by means of downloading or the like on the basis of data delivery using the GET/POST method in the HTTP, as shown in FIG. 5.

In addition, each of the client terminals 132, 133 and 134 accesses the ADSL router 131, and data is transmitted from each of the client terminals 132, 133 and 134 to the ADSL router 131.

The HTTP/mirror server section 131B in the ADSL router 131 sums up data transmitted from the client terminals 132, 133 and 134, and transmits the summed up data collectively to the network monitoring machine 101 serving as the parent server, at regular intervals.

This makes it easy to expand the transmission content alteration function, makes possible load distribution, and makes it possible to construct a large scale data summing up system in a remote business or the like. Since the HTTP is installed on the ADSL router 131 as one body, there is an advantage that the required quantity of resources is small.

As a result, it becomes possible to monitor not only the line state but also the session state. Accordingly, it becomes possible for the network manager to suitably cope with a user, such as a beginner, who is not strong on fault cause analysis.

By the way, the HTTP is used as the protocol for information transmission and reception. However, the protocol is not limited to the HTTP, but the protocol may be, for example, an electronic mail form of the SMTP (Simple Mail Transfer Protocol). In this case, the HTTP/mirror server section 131B in the ADSL router 131 is replaced by an SMTP/mirror server section 131C (not illustrated).

### Fifth Embodiment

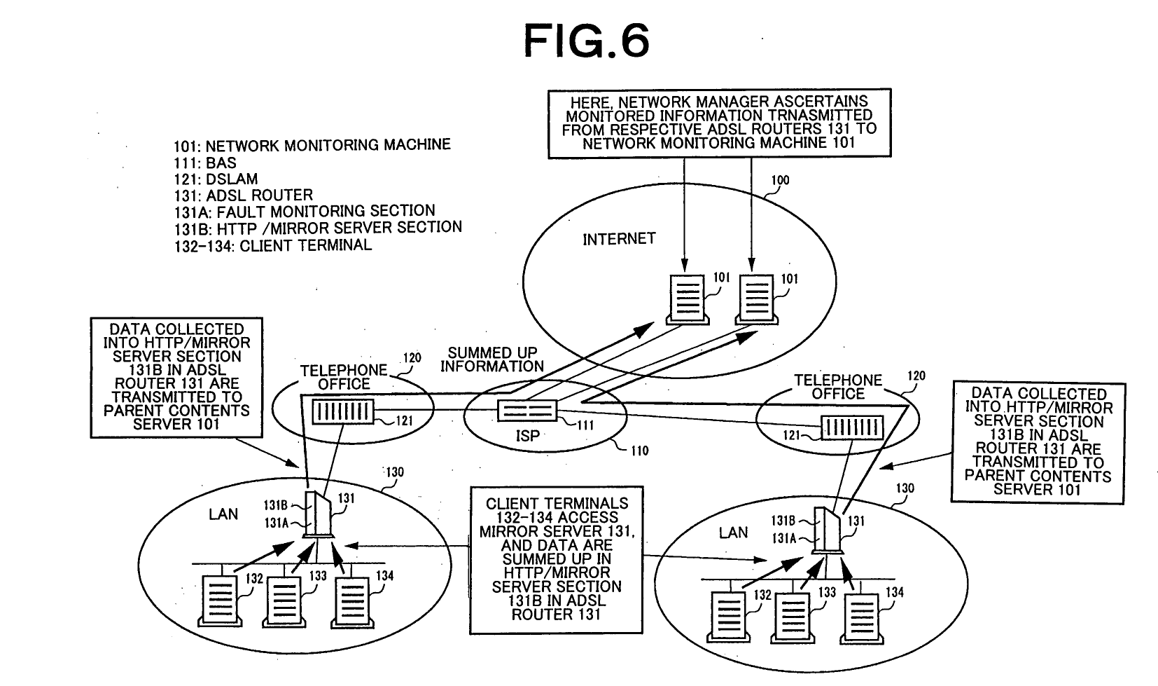

FIG. 6 is a diagram showing a variant of FIG. 5 and it is a diagram showing another operation example in the HTTP/mirror server section 131B in the ADSL router 131.

As compared with FIG. 5, in the load distribution type network fault monitoring system of the ADSL router shown in FIG. 6, a plurality of network monitoring machines 101 are provided on the Internet 100, and a network monitoring machine 101 on the Internet 100 of the transmission destination is set for each of the HTTP/mirror server section 131B respectively in ADSL routers 131.

In other words, each of the network monitoring machines 101 serves as a parent contents server for an ADSL router 131, and the ADSL router 131 serves as a child server for the network monitoring machine 101.

As a result, it becomes possible to install a plurality of network monitoring machines 101 in the Internet 100, and the load on the network monitoring machine 101 side can be further reduced as compared with the monitoring processing shown in FIG. 5.

1. A load distribution type network fault monitoring system of a broadband router, which is connected to a plurality of client terminals and which has a function of accessing the Internet, the load distribution type network fault monitoring system comprising:
a fault monitoring section in the broadband router for monitoring and recording a connection situation between the client terminals and the broadband router, and an abnormality in data communication contents; and
a network monitoring machine connected to the Internet to receive collectively the connection situation and the abnormality in data communication contents monitored by the fault monitoring section, at regular intervals, sum up the received data, and ascertain a network state.

2. The load distribution type network fault monitoring system of the broadband router according to claim 1, wherein
the fault monitoring section monitors a physical line error between the broadband router and an office side line accommodation apparatus connected to the broadband router, and a PPP session state between the broadband router and a BAS (Broadband Access Server) which is connected between the office side line accommodation apparatus and the Internet, and records the monitored line error and PPP session state, and
the network monitoring machine receives the physical line error and the PPP session state monitored by the fault monitoring section, collectively at regular intervals, sums up the received data, and ascertains the network state.

3. The load distribution type network fault monitoring system of the broadband router according to claim 2, wherein
if the physical line error is a physical line disconnection, then the fault monitoring section records a line disconnection situation and a PPP session state, and
after the line restoration has been detected, the fault monitoring section transmits the recorded line disconnection situation PPP session state.

4. The load distribution type network fault monitoring system of the broadband router according to claim 1, wherein
a plurality of network monitoring machines are provided on the Internet, and
a network monitoring machine serving as transmission destination of the monitored connection situation and abnormality in data communication contents, or the monitored physical line error and PPP session state is set for each of the fault monitoring sections in the broadband routers.

5. The load distribution type network fault monitoring system of the broadband router according to claim 1, wherein
the broadband router comprises an HTTP/mirror server section in which the HTTP is installed,
the HTTP/mirror server section has a mirror server function for the network monitoring machine, and
the HTTP/mirror server section downloads mirrored contents from the network monitoring machine, sums up data transmitted in access from the client terminals, and transmits the summed up data collectively to the network monitoring machine at regular intervals.

6. The load distribution type network fault monitoring system of the broadband router according to claim 1, wherein
the broadband router comprises an SMTP/mirror server section in which the SMTP is installed,
the SMTP/mirror server section has a mirror server function for the network monitoring machine, and
the SMTP/mirror server section downloads mirrored contents from the network monitoring machine, sums up data transmitted in access from the client terminals, and transmits the summed up data collectively to the network monitoring machine at regular intervals.

7. A load distribution type network fault monitoring method of a broadband router, which is connected to a plurality of client terminals and which has a function of accessing the Internet, the load distribution type network fault monitoring method comprising the steps of:
monitoring and recording a connection situation between the client terminals and the broadband router, and an abnormality in data communication contents; and
receiving collectively the monitored connection situation and abnormality in data communication contents, via the Internet at regular intervals, summing up the received data, and ascertaining a network state.

8. The load distribution type network fault monitoring method of the broadband router according to claim 7, wherein
monitoring a physical line error between the broadband router and an office side line accommodation apparatus connected to the broadband router, and a PPP session state between the broadband router and a BAS (Broadband Access Server) which is connected between the office side line accommodation apparatus and the Internet, and recording the monitored line error and PPP session state, and
receiving the physical line error and the PPP session state monitored at the fault monitoring step, collectively at regular intervals, summing up the received data, and ascertaining the network state.

9. The load distribution type network fault monitoring method of the broadband router according to claim 8, wherein
recording a line disconnection situation and a PPP session state, if the physical line error is a physical line disconnection, and
transmitting the recorded line disconnection situation PPP session state, after the line restoration has been detected.

10. The load distribution type network fault monitoring method of the broadband router according to claim 7, wherein
monitoring connection situation and abnormality in data communication contents, or the monitoring physical line error and PPP session state, for each of the broadband routers.

11. The load distribution type network fault monitoring method of the broadband router according to claim 7, wherein
downloading mirrored contents at the network monitoring step, summing up data transmitted in access from the client terminals, and transmitting the summed up data collectively via the Internet at regular intervals by the HTTP/mirror server function.

12. The load distribution type network fault monitoring method of the broadband router according to claim 7, wherein
downloading mirrored contents at the network monitoring step, summing up data transmitted in access from the client terminals, and transmitting the summed up data collectively via the Internet at regular intervals by the SMTP/mirror server function.
